(19) United States
(12) Patent Application Publication
(10) Pub. No.: US 2025/0027966 A1
(43) Pub. Date: Jan. 23, 2025

(54) A MICROFLUIDIC DEVICE TO DISPENSE A METABOLIC INDICATOR

(71) Applicant: Hewlett-Packard Development Company, L.P., Spring, TX (US)

(72) Inventors: Raghuvir N. Sengupta, Palo Alto, CA (US); Viktor Shkolnikov, Palo Alto, CA (US); Steven Barcelo, Palo Alto, CA (US)

(73) Assignee: Hewlett-Packard Development Company, L.P., Spring, TX (US)

(21) Appl. No.: 18/713,157

(22) PCT Filed: Dec. 15, 2021
(86) PCT No.: PCT/US2021/063599

§ 371 Date: May 23, 2024

(51) Int. Cl. G01N 35/10

(52) U.S. Cl. CPC G01N 35/1016; G01N 2035/1034

(57) ABSTRACT

In accordance with the present disclosure, an example non-transitory computer readable medium may store instructions that when executed cause a computing device to dispense, using a first fluid ejector of a microfluidic device, a biologic sample to a region of a substrate, dispense, using a second fluid ejector of the microfluidic device, a reagent to the region of the substrate, and dispense, using a third fluid ejector of the microfluidic device, a metabolic indicator to the region of the substrate, wherein the metabolic indicator provides a visual indication in response to reaction with the biologic sample.

### BACKGROUND

Microfluidics applies across a variety of disciplines including engineering, physics, chemistry, microtechnology and biotechnology. Microfluidics involves the study of small volumes, e.g., microliters, picoliters, or nanoliters, of fluid and how to manipulate, control and use such small volumes of fluid in various microfluidic systems and devices. For example, microfluidic biochips are used in the field of molecular biology to integrate assay operations for purposes such as analyzing enzymes and deoxyribonucleic acid (DNA), detecting biochemical toxins and pathogens, diagnosing diseases, etc.

### BRIEF DESCRIPTION OF THE DRAWINGS

FIG. 1 illustrates an example computing device in accordance with the present disclosure.

FIGS. 2A, 2B, and 2C illustrate operation of an example apparatus including a microfluidic device to dispense a metabolic indicator, in accordance with the present disclosure.

FIG. 3 illustrates a portion of an example apparatus including an integrated imaging stage, in accordance with examples of the present disclosure.

FIG. 4 illustrates an example apparatus including a turbidity meter, in accordance with examples of the present disclosure.

FIG. 5 illustrates an example apparatus for continuous testing of multiple substrates, in accordance with examples of the present disclosure.

FIG. 6 illustrates data demonstrating the capability to observe levels of antibiotic activity as described in the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Different types of tests and/or chemical reactions may involve manual handling and manipulation of reagents and/or sample fluid being tested by a user, such as pipetting fluids to a substrate. Manual handling may be burdensome and may reduce efficiencies in performing the operations and increase risk for errors. In some instances, microfluidic devices may be used to perform operations on fluids, which may reduce manual handling of fluid components. The microfluidic device may be a cartridge which is loaded with different fluids, and inserted or disposed in a fluid dispending device to selectively eject fluids to a substrate. For some tests, and even with the use of microfluidic devices, reagents may be manually handled and/or manipulated. For example, for antibiotic susceptibility test, such as broth dilution assays and Epsilometer test (E-test), bacterial inoculum may be added to regions of substrate with different antibiotics, which are inoculated together and assessed optically to evaluate the amount of bacterium remaining. In some instances, a single antibiotic of a particular concentration is tested per region of the substrate. For antibiotic susceptibility tests and other types of tests, different combinations of reagents and concentrations may be tested, with microfluidic devices being used to increase testing volume and minimize user handling. The microfluidic device may be loaded with different reagents and used to eject different combinations and concentrations of the reagents.

One treatment strategy to combat antibiotic resistance is the administration of two or more antibiotics to a patient, enabling a stronger treatment effect by leveraging the distinct physiochemical properties of different antibiotics. To evaluate which combination of antibiotics are most effective in treating bacterial infections, methods may be developed to evaluate whether the interactions between different antibiotics are synergistic (i.e. have a stronger antibiotic effect) or antagonistic (i.e. have a weaker antibiotic effect). However, such antibiotic interaction testing is not feasible with many antibiotic susceptibility methods (e.g. agar and broth dilution assays) due to increases in throughput, manual handling, and time.

A microfluidic device to dispense a metabolic indicator, in accordance with the present disclosure, allows users to exert control over the level of throughput in fluid dispense tests, including antibiotic susceptibility testing. The microfluidic device of the present disclosure provides the ability to dispense various combinations of fluids (including antibiotics) on a substrate, and allows for rapid, accurate, repeatable and automated combinatorial tests. In various examples of the present disclosure, bacterial growth may be monitored via a metabolic indicator, allowing results to be quickly.

In accordance with the present disclosure, an example non-transitory computer readable medium may store instructions that when executed cause a computing device to dispense, using a first fluid ejector of a microfluidic device, a biologic sample to a region of a substrate, dispense, using a second fluid ejector of the microfluidic device, a reagent to the region of the substrate, and dispense, using a third fluid ejector of the microfluidic device, a metabolic indicator to the region of the substrate, wherein the metabolic indicator provides a visual indication in response to reaction with the biologic sample.

In some examples, the non-transitory computer readable medium includes instructions that when executed cause the computing device to dispense, using the second fluid ejector, a combination of a plurality of different reagents into the region of the substrate. In some examples, the reagent is to cause a chemical reaction with the biologic sample, and the non-transitory computer readable medium further includes instructions that when executed cause the computing device to agitate the substrate by moving the substrate along a plane. In some examples, the reagent is a first reagent, and the instructions to dispense the reagent to the region of the substrate includes instructions that when executed cause the microfluidic device to dispense using the second fluid ejection device, a second reagent to the region of the substrate. In some examples, the region of the substrate is a first region, and the non-transitory computer readable medium further includes instructions that when executed cause the microfluidic device to dispense in the first region of the substrate, a first combination of the first reagent and the second reagent, and dispense in a second region of the substrate, a second combination of the first reagent and the second reagent. In some examples, the region of the substrate is a first region, and the non-transitory computer readable medium further includes instructions that when executed cause the microfluidic device to dispense in a second region of the substrate, a combination of the first reagent and a third reagent.

In some examples, the non-transitory computer readable medium further includes instructions that when executed cause the computing device to measure a level of visual indication at the region of the substrate, and determine a level of efficacy of the reagent based on the level of visual indication at the region.

An example apparatus in accordance with the present disclosure, comprises a dispense head including a first fluid ejector of a microfluidic device to dispense a biologic sample to a region of a substrate, a second fluid ejector of the microfluidic device to dispense a reagent to the region of the substrate, and a third fluid ejector of the microfluidic device to dispense a metabolic indicator to the region of the substrate, wherein the metabolic indicator provides a visual indication in response to reaction with the biologic sample. The apparatus further includes an imaging device to obtain a measurement of the metabolic indicator.

In some examples, the apparatus further includes a chamber to receive the substrate and incubate the biologic sample. In some examples, the metabolic indicator includes a fluorogenic compound and the imaging device includes a fluorimeter. In some examples, the reagent includes an antibiotic, an enzyme, a nucleotide, an antibody, a metabolic indicator, a detectable label, and combinations thereof. In some examples, the apparatus further includes a turbidity meter.

Another example apparatus in accordance with the present disclosure includes a dispense head of a microfluidic device including a first fluid ejector to dispense a biologic sample to a region of a substrate, a second fluid ejector to dispense a reagent to the region of the substrate, and a third fluid ejector of the microfluidic device to dispense a metabolic indicator to the region of the substrate, wherein the metabolic indicator provides a visual indication in response to reaction with the biologic sample. The example apparatus further includes an imaging device to obtain a measurement of the metabolic indicator, and an integrated imaging stage including an array of excitation light-emitting diodes (LEDs), and an indium tin oxide (ITO) coated glass layer.

In some examples, the integrated imaging stage further includes a red or infrared LED. In some examples, the ITO coated glass layer is to heat the substrate responsive to application of red or infrared light, and wherein the integrated imaging stage further includes an array of sensor photodiodes to capture fluorescent measurements from the metabolic indicator on the substrate.

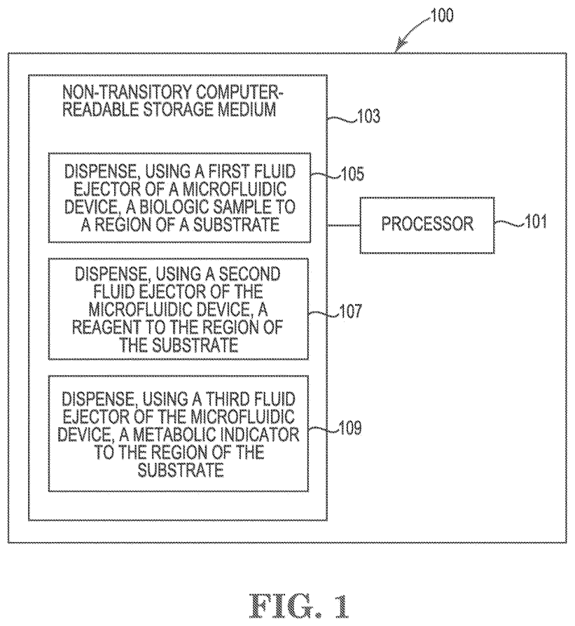

Turning now to the figures, FIG. 1 illustrates an example computing device 100 in accordance with the present disclosure. As illustrated in FIG. 1, the computing device 100 may include a processor 101, and a computer-readable storage medium 103.

The processor 101 may be a central processing unit (CPU), a semiconductor-based microprocessor, and/or other hardware device suitable to control operations of the computing device 100. Computer-readable storage medium 103 may be an electronic, magnetic, optical, or other physical storage device that contains or stores executable instructions. Thus, computer-readable storage medium 103 may be, for example, Random Access Memory (RAM), an Electrically Erasable Programmable Read-Only Memory (EEPROM), a storage device, an optical disc, etc. In some examples, the computer-readable storage medium 103 may be a non-transitory storage medium, where the term ‘non-transitory’ does not encompass transitory propagating signals. As described in detail below, the computer-readable storage medium 103 may be encoded with a series of executable instructions 105-109.

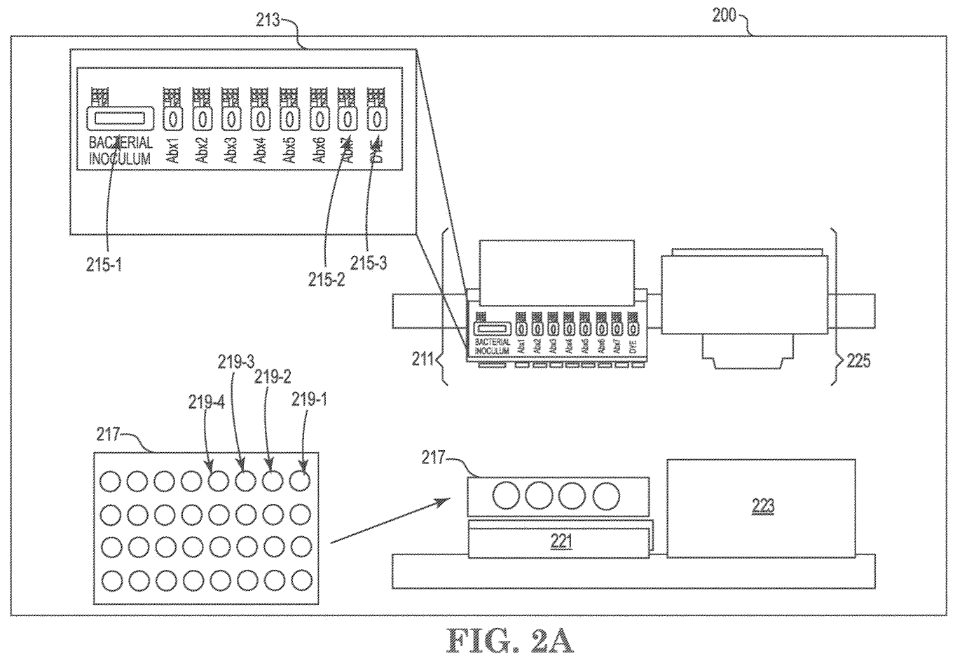

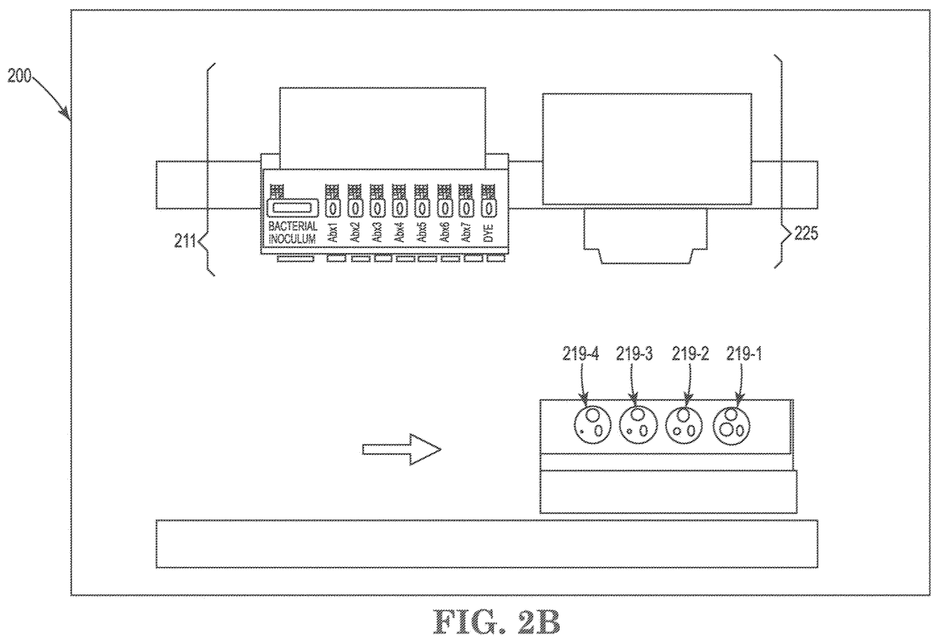

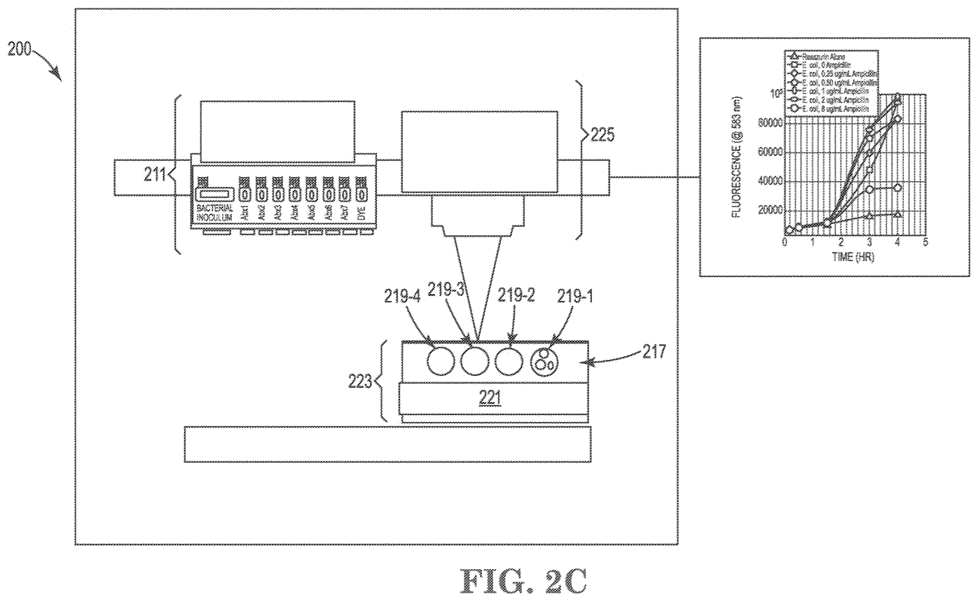

In some examples, computer-readable storage medium 103 includes instructions 105 that when executed, cause a computing device to dispense, using a first fluid ejector of a microfluidic device, a biologic sample to a region of a substrate. For instance, as discussed with regards to FIG. 2A, each region of the substrate may include the sample fluid and, in other examples, the dispense head 213 may dispense the sample fluid to each region of the substrate 217.

In some examples, the computer-readable storage medium 103 includes instructions 107 that when executed, cause a computing device to dispense, using a second fluid ejector of the microfluidic device, a reagent to the region of the substrate. A reagent, as used herein, includes and/or refers to a substance for use in a biochemical analysis or reaction. The type of reagent(s) used may depend on the test to be performed. Non-limiting examples of reagents that may be used in accordance with the present disclosure include an antibiotic, an enzyme, a nucleotide, an antibody, a metabolic indicator, a detectable label, and combinations thereof. In some examples, a plurality of different reagents, such as different antibiotics, different antibodies, different enzymes, etc., and/or different concentrations of a reagent may be dispensed.

In some examples, the computer-readable storage medium 103 includes instructions 109 that when executed, cause a computing device to dispense, using a third fluid ejector of the microfluidic device, a metabolic indicator to the region of the substrate, wherein the metabolic indicator provides a visual indication in response to reaction with the biologic sample.

In some examples, the computer-readable storage medium 103 includes instructions that when executed, cause the computing device to dispense, using the second fluid ejector, a combination of a plurality of different reagents into the region of the substrate. For instance, a variety of different antibiotic combinations may be dispensed, such that one combination of antibiotics may be compared to another combination of antibiotics for antibiotic susceptibility testing.

In any of the above examples, the computing device may identify which respective fluid ejectors are associated with or correspond to which fluid or semi-fluid substances (e.g., the reagent(s), biologic sample, and/or metabolic indictor), which may be referred to as the “substances”, and in response to the identification, cause dispensing of a respective substance using the identified fluid ejector. The computing device may identify respective fluid ejectors as being associated with or corresponding to respective substances based on user-provided indications (e.g., user inputs to the computing device identifying each fluid ejector and corresponding substance) or pre-determined locations for fluid ejectors associated with or corresponding to the respective substances. The pre-determined locations may be selected by the computing device and provided as an instruction to the user on where to load the substances. In other examples, the pre-determined locations may be set by mechanical interfaces on the microfluidic device which restrict which substance may be loaded where, and/or may be set by the manufacturer of the dispense head and the computing device may identify the type of dispense head loaded into the microfluidic device. For example, the dispense head may include an identifier (e.g., bar code or other data) that is readable by the computing device and which identifies the type of dispense and/or identifies the respective fluid ejectors and corresponding substances.

In some examples, the reagent may cause a chemical reaction with the biologic sample. In such examples, the computer-readable storage medium 103 may include instructions that when executed cause the computing device 100 to agitate the substrate by moving the substrate along a plane. For instance, the substrate may be agitated to facilitate reactions between the sample fluid, the reagent, and the metabolic indicator.

In some examples, the reagent is a first reagent, and the instructions 107 to dispense the reagent to the region of the substrate include instructions that when executed cause the microfluidic device to dispense using the second fluid ejection device, a second reagent to the region of the substrate.

In some examples, the region of the substrate is a first region, and the non-transitory computer readable medium 103 further includes instructions that when executed cause the microfluidic device to dispense in the first region of the substrate, a first combination of the first reagent and the second reagent, and dispense in a second region of the substrate, a second combination of the first reagent and the second reagent.

In some examples, the region of the substrate is a first region, and the non-transitory computer readable medium 103 further includes instructions that when executed cause the microfluidic device to dispense in a second region of the substrate, a combination of the first reagent and a third reagent.

In some examples, the non-transitory computer readable medium 103 further includes instructions that when executed cause the computing device to measure a level of visual indication at the region of the substrate, and determine a level of efficacy of the reagent based on the level of visual indication at the region.

FIGS. 2A, 2B, and 2C illustrate operation of an example apparatus 200 including a microfluidic device 211 to dispense a metabolic indicator, in accordance with the present disclosure. For instance, FIG. 2A illustrates an apparatus 200 for dispensing a metabolic indicator, in accordance with the present disclosure. The microfluidic device 211 may be formed of a structural component, such as silicon, a polymeric material, an epoxy-based negative photoresist (such as SU-8), or the like. The structural component may be formed through implementation of microfabrication techniques such as electroforming, laser ablation, anisotropic etching, sputtering, dry and wet etching, photolithography, casting, molding, stamping, machining, spin coating, laminating, and the like.

In the example illustrated in FIG. 2A, the apparatus 200 includes a microfluidic device 211 that includes a dispense head 213 and a plurality of fluid ejectors 215. As used herein, a microfluidic device refers to or includes a device including circuitry and capable of manipulation and control of small volumes of fluid through microfluidic fluidic channels. As used herein, a microfluidic channel (also referred to herein as a “channel”) refers to or includes a path through which a fluid or semi-fluid substance may pass, which may enable transportation of volumes of fluid on the order of microliters (i.e., symbolized pL and representing units of 10 6 liter), nanoliters (i.e., symbolized nL and representing units of 10 9 liter), picoliters (i.e., symbolized pL and representing units of 10 12 liter) or femtoliters (i.e., symbolized fL and representing units of 10 15 liter). As used herein, a microfluidic ejector refers to or includes a firing chamber to receive a fluid and expel a portion of the fluid therefrom. As used herein, the term “fluid” refers to or includes any material containing particles of interest, such as for example, foods and allied products, clinical, and environmental samples. However, the fluid referred to herein may be a biological sample, which may contain any viral or cellular material, including all prokaryotic or eukaryotic cells, viruses, bacteriophages, mycoplasmas, protoplasts, and organelles. Such biological material may thus comprise all types of mammalian and non-mammalian animal cells, plant cells, algae including blue-green algae, fungi, bacteria, protozoa, etc. Representative fluids thus include whole blood and blood-derived products such as plasma, serum and buffy coat, urine, feces, cerebrospinal fluid or any other body fluids, tissues, cell cultures, cell suspensions, etc.

A fluid ejector may include a plurality of components which permit fluid to be ejected therefrom. For instance, the fluid ejector may include an actuator and a nozzle in fluid communication with a channel. The actuator may be positioned in line with the nozzle. For instance, the actuator may be positioned directly above or below the nozzle. Activation of the actuator may cause some of the fluid contained in the channel to be dispensed or expelled out of the microfluidic ejector through the nozzle. In various examples, fluid may be ejected by droplet from the microfluidic ejector via a pulse of current that is passed through the actuator. Heat from the actuator may cause a rapid vaporization of the fluid in the microfluidic ejector to form a drive bubble, which causes a large pressure increase that propels a droplet of fluid out of the microfluidic ejector via the nozzle. In some examples, the microfluidic ejector can dispense fluid out of the nozzle via a piezoelectric process. In such piezoelectric processes, a voltage may be applied to the actuator in the form of a piezoelectric material. When a voltage is applied, the piezoelectric material changes shape, which generates a pressure pulse that forces a droplet of fluid from the microfluidic ejector via the nozzle. It is appreciated that other forms of microfluidic ejector can be used in accordance with the present disclosure. Each microfluidic fluidic ejector may include a plurality of components, including an actuator and a nozzle. In general, the structures and components of the fluidic ejectors may be fabricated using integrated circuit microfabrication techniques such as electroforming, laser ablation, anisotropic etching, sputtering, dry and wet etching, photolithography, casting, molding, stamping, machining, spin coating, laminating, and the like.

In various examples, the dispense head 213 may, via the fluid ejectors 215, precisely dispense fluids such as a bacterial inoculum, an antibiotic or a combination of antibiotics, and a fluorogenic substrate. During operation, a user may load the dispense head 213 and subsequently add the various fluids (e.g., bacterial inoculum, antibiotics, dye, etc.). In various examples, the apparatus 200 may further include a processor (such as processor 101 illustrated in FIG. 1) and a computer readable medium (such as computer readable medium 103 illustrated in FIG. 1). The processor, when executing instructions stored in the computer readable medium, may allow the apparatus 200 to operate in the manner described herein. For instance, the processor may execute instructions stored in the computer readable medium (e.g., instructions 105, 107, and 109) to dispense fluids on substrate 217.

The apparatus 200 may also include a substrate 217. The substrate 217 may comprise a silicon based wafer or other similar materials used for microfabricated devices (e.g., glass, gallium arsenide, plastics, etc.). In some examples, the substrate 217 includes different regions 219-1, 219-2, 219-3 (referred to collectively herein as regions 219), such as wells of a well plate, with each region getting a different amount of a reagent and/or different mixture of the reagents. In some examples, each region of the substrate 217 may include the sample fluid and, in other examples, the dispense head 213 may dispense the sample fluid to each region of the substrate 217. These dispense locations may be specific target regions on the substrate surface, such as cavities, microwells, channels, indentation into the substrate, or other regions of the substrate. As used herein, a microwell includes and/or refers to a column capable of storing a volume of fluid between a nanoliter and several milliliters of fluid.

In some examples, the dispense head 213 includes a first fluid ejector 215-1 of a microfluidic device 211 to dispense a biologic sample to a region of the substrate 217 (such as region 219-1), a second fluid ejector 215-2 of the microfluidic device 211 to dispense a reagent to the region of the substrate 217 (such as region 219-1), and a third fluid ejector 215-3 of the microfluidic device 211 to dispense a metabolic indicator to the region of the substrate 217 (such as region 219-1). As used herein, a metabolic indicator includes and/or refers to a molecule or compound that transforms to an optical indicator in the presence of particular cells, such as molecules that enzymes act upon. An optical indicator includes and/or refers to a molecule or compound that is optically detectable, such as a fluorescent molecule or compound. The optical indicator may be detected visually (e.g., by the human eye) or using a detector, such as via colorimetric, fluorescence, or other luminescence detection, such as Raman. As such, the metabolic indicator may provide a visual indication in response to reaction with the biologic sample.

In some examples, the metabolic indicator includes a fluorogenic compound. A non-limiting example of a fluorogenic compound that may be used as a metabolic indicator includes resazurin which is transformed to resorufin when mixed with living cells, such as with bacteria. When mixed with cells, resazurin diffuses into the cell where it is irreversibly reduced to resorufin within the cell. The resorufin may further reversibly reduced to dihydroresorufin. Resorufin is fluorescent, which allows for monitoring the reaction. For example, resorufin is excited at around 540 nanometers (nm) and emits around 590 nm. Living cells, such as bacteria, may be mixed with resazurin for around one to four hours. For example, after incubation and to overcome the background signal, around 7×106 colony forming unit per milliliter (cfu/mL) of Escherichia coli may be present.

Examples are not limited to resorufin, and other types of metabolic indicators or detectable labels may be used. Other example metabolic indicators include nitrophenol, 4-methylumbelliferone (4-MU), 7-amin-4-methylcoumarin (7-AMC), 7-hydrocycoumarin-3-carboxylate (EHC), fluorescein, dihydroxynapthalenes, indoxyl, Aldols™, and ELF™. In some examples, a metabolic indicator may not be used. For example, a reagent may be labeled with a detectable label, such as optically (e.g., attached fluorophore) or electrically labeled antibody or enzyme. In other examples, the biochemical reaction may be observed and/or analyzed without any labels and/or metabolic indicators. A detectable label, as used herein, includes and/or refers to a compound or molecule that may be detected optically, electrically, or otherwise.

In various examples, the substrate 217 may be disposed on a movable stage 221. The stage, as used herein, refers to or includes any form of structural material that is capable of holding the substrate 217 and moving in the X, Y, and Z directions. The stage 221 may move in the X, Y, and Z directions to allow for dispensing of sample fluid, reagent, and/or metabolic indicators into various regions of the substrate 217. Additionally, the stage 221 may move in the X, Y, and Z directions to move the substrate 217 to different areas of the apparatus 200. For example, the stage 221 may move the substrate 217 such that the substrate 217 is contained within a heating chamber 223. The heating chamber 223 may heat the plurality of regions 219 of the substrate 217 to drive a biochemical reaction (e.g., incubation) between the ejected reagents and the sample fluid. As such, the apparatus 200 may include a chamber (e.g., heating chamber 223) to receive the substrate and incubate the biologic sample.

In some examples, the apparatus 200 further includes an imaging device 225 to obtain a measurement of the metabolic indicator. For instance, in some examples, the metabolic indicator includes a fluorogenic compound and the imaging device 225 includes a fluorimeter.

FIG. 2B illustrates the example apparatus 200 of FIG. 2A with a moved stage, in accordance with the present disclosure. Following the dispense step, the stage 221 may be moved (e.g., via execution of instructions by the processor illustrated in FIG. 1) to a heating chamber 223. The heating chamber may be set to any of a number of different temperatures based on the test being performed. For instance, the heating chamber 223 may be set at 37° C. to enable bacterial growth in the regions of the substrate 217.

In some examples, the stage 221 may move within the heating chamber 223 to repeatedly agitate the fluid (such as bacterial suspensions) on the substrate 221. Examples are not so limited, however, and additional agitation and/or mixing means may be employed. For instance, for small wells (such as a 1500 well plate) the solution may not be effectively agitated due to the solution not having a large inertia. As such, high density beads (such as lead) that do not move faithfully with the fluid inside the regions on the substrate 211 may be included in the regions to further agitate the solution in each region of the substrate 221.

Imaging measurements can be made at various times during the incubation period, thereby enabling results to be reported as soon as a statistically significant signal is detected. For instance, fluorescence measurements may be captured by imaging device 215 while the substrate 221 is disposed within the heating chamber 223, and responsive to execution of instructions by the processor may report results as soon as a statistically significant signal is detected.

FIG. 2C illustrates the example apparatus 200 of FIG. 2A while the imaging device is capturing images of the substrate, in accordance with the present disclosure. As described with regards to FIG. 2B, the imaging device 215 may capture images at any point in time, and/or once a statiscially significant signal is detected. Also, as described with regards to FIG. 2A, resazurin reduction results in an increase in fluorescence. Accordingly, as bacterial concentration increases over time, more resazurin reduction results and the result is an increase in fluorescence. Antibiotic combinations that disrupt bacterial growth may therefore have less fluorescence than those combinations which have no effect. As an example, region 219-4, region 219-3, and region 219-2 may include antibiotics and/or antibiotic combinations that are less effective than the antibiotic and/or antibiotic combination used in region 219-1. This conclusion may be obtained, because region 219-4, region 219-3, and region 219-2 each have a greater fluorescence level as compared to region 219-1, which is the result of more resazurin reduction by living cells (such as bacteria).

Fluorescence data captured by the imaging device 215 may be reported by the processor (e.g., processor 101 illustrated in FIG. 1) executing instructions stored in a computer readable medium, and displayed (such as on a graphical user interface) to allow a user to identify which combinations of antibiotics are most effective in killing bacteria. Background conversion of resazurin to resorufin (in absence of bacteria) can be calibrated out for increased sensitivity and reduction of assay time. Moreover, the minimum inhibitory concentration of the antibiotic (or antibiotic combination) can be measured, because the microfluidic device 211 is capable of dispensing very small volumes of reagents (e.g., antibiotics), as well as precise volumes of reagent combinations. The rate of fluorescence increase can be correlated to bacterial growth rate and thus the inhibition potential of a particular antibiotic can be measured, as illustrated in the graph included in FIG. 2C. This fluorescence readout may be obtained between 3 and 6 hours, and may thus be used for fast determination of combinations of antibiotics for antibiotic treatment.

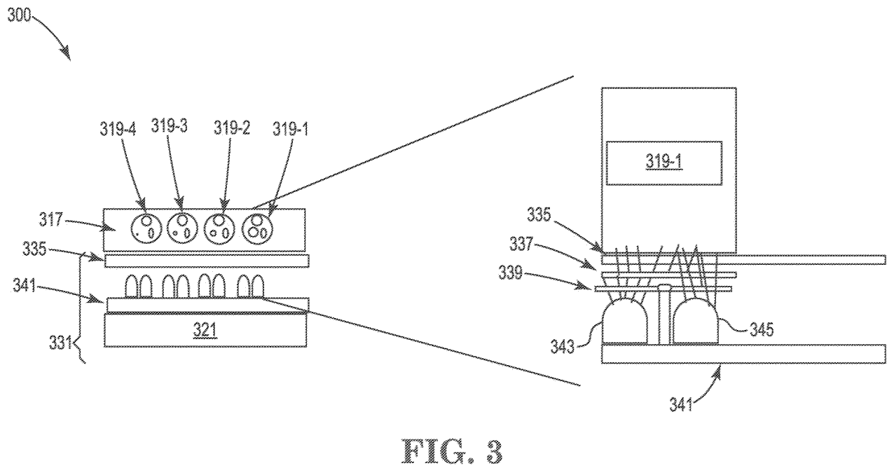

FIG. 3 illustrates a portion of an example apparatus 300 including an integrated imaging stage 331, in accordance with examples of the present disclosure. In general, the apparatus 300 shown in FIG. 3 may include various components that are the same and/or substantially similar to components discussed with regards to FIG. 1, FIG. 2A, FIG. 2B, and/or FIG. 2C, which were described in greater detail above. As such, for brevity and ease of description, various details relating to certain components discussed with regards to FIG. 1, FIG. 2A, FIG. 2B, and/or FIG. 2C, may be omitted herein to the extent that the same or similar details have already been provided.

In the example illustrated in FIG. 3, an integrated imaging stage 331 may include an array of excitation light-emitting diodes (LEDs) 333, and an indium tin oxide (ITO) coated glass layer 335. In this example, the imaging device (e.g., 215 illustrated in FIG. 2A, for example) and heating chamber (e.g., chamber 223 illustrated in FIG. 2A, for example) are integrated by placing a printed circuit board (PCB) 341 above the stage 221. As illustrated in the exploded view of FIG. 3, the PCB 341 includes excitation LEDs 343 and sensor photodiodes 345 with a filter array for fluorescence measurements. In the example illustrated in FIG. 3, the filter array includes an optional excitation filter 339 and an emission filter 347. Use of an integrated imaging stage (such as 331 illustrated in FIG. 3) provides an additional advantage of simultaneous fluorescence detection of the regions of the substrate 317. In some examples, the PCB may further include a red or infrared heater LED disposed on the PCB (such as, for instance, adjacent to LED 345) which may be used for heating the sample in the region 319-1.

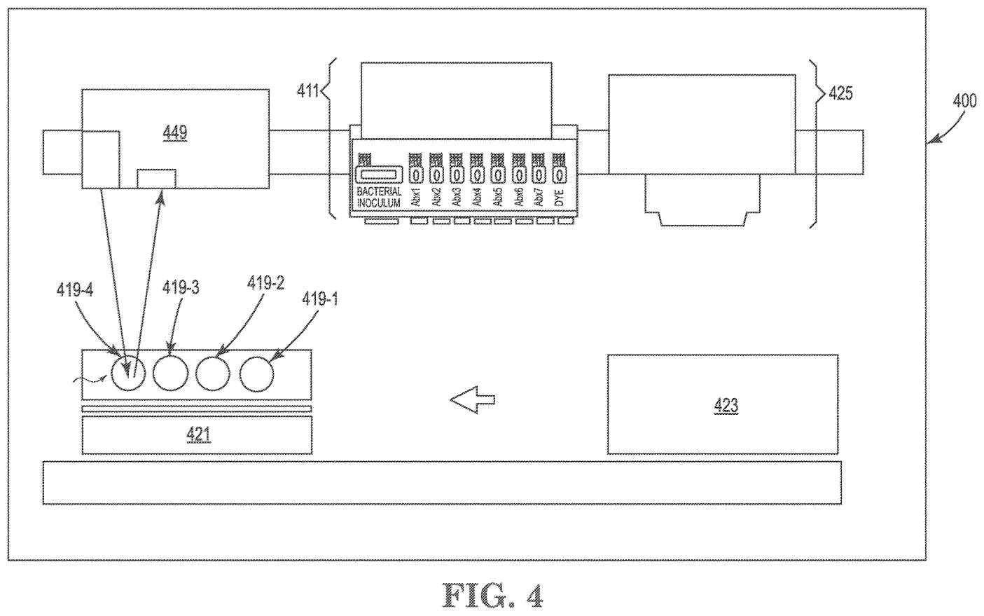

FIG. 4 illustrates an example apparatus 400 including a turbidity meter 449, in accordance with examples of the present disclosure. In general, the apparatus 400 shown in FIG. 4 may include various components that are the same and/or substantially similar to components discussed with regards to FIG. 1, FIG. 2A, FIG. 2B, and/or FIG. 2C, which were described in greater detail above. As such, for brevity and ease of description, various details relating to certain components discussed with regards to FIG. 1, FIG. 2A, FIG. 2B, and/or FIG. 2C, may be omitted herein to the extent that the same or similar details have already been provided.

In various examples, the apparatus 400 may include a turbidity meter 449 for measuring the cell density of a fluid sample. For instance, prior to dispensing antibiotics, dye, and/or other components in a fluid sample, the concentration of the bacterial inoculum may be determined. In such examples, a user can load the inoculum on the dispense head 411 and dispense this onto a junk well (such as region 419-4) within the substrate. The stage 421 containing the microplate may move in the direction of the arrow so that the substrate 421 is below the turbidity meter 449. The turbidity meter 449 may be attached to the device 400 and normalized to McFarland standards so that the turbidity meter 449 can be used to measure the concentration of bacteria in regions 419-1, 419-2, and 419-3.

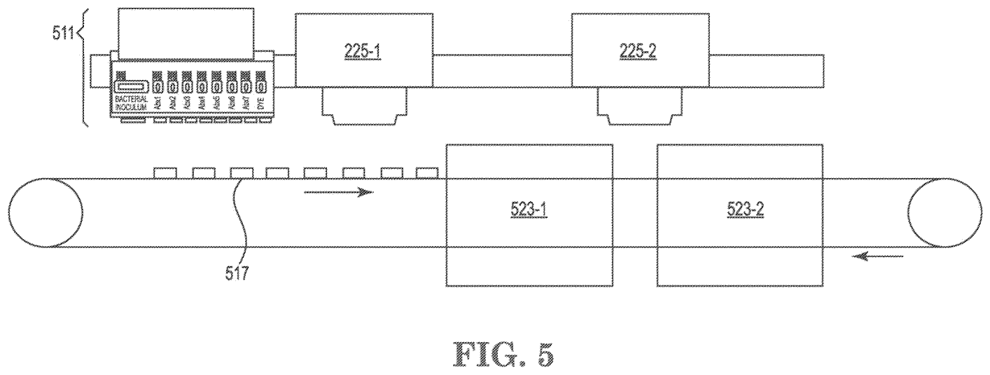

FIG. 5 illustrates an example apparatus 500 for continuous testing of multiple substrates, in accordance with examples of the present disclosure. In general, the apparatus 500 shown in FIG. 5 may include various components that are the same and/or substantially similar to components discussed with regards to FIG. 1, FIG. 2A, FIG. 2B, and/or FIG. 2C, which were described in greater detail above. As such, for brevity and ease of description, various details relating to certain components discussed with regards to FIG. 1, FIG. 2A, FIG. 2B, and/or FIG. 2C, may be omitted herein to the extent that the same or similar details have already been provided.

In the example apparatus 500 illustrated in FIG. 5, multiple substrates (enumerated simply as substrates 517) can be loaded in a conveyer belt system. Each substrate among the plurality of substrates may move through the microfluidic device 511 and through one or more heating chambers 523-1, 523-2 and one or more imaging devices 525-1, 525-2. The number of heating chambers and imaging devices may be determined by the number of substrates being tested. For each substrate, a biologic sample (e.g., a fluid sample), and a reagent may be dispensed into the regions on the substrates 517, as discussed herein. After dispensing, each substrate may be moved to the imaging devices 525-1, 525-2, then to the heating chambers 523-1, 523-2, then back to the imaging devices 525-1, 525-2, and back to the heating chambers 523-1, 523-2, and so forth.

In any of the above-described examples, the biologic sample may be pre-deposited on the substrate, such that the biologic sample is not dispensed by a fluid ejection device and/or by an apparatus. As a specific example, bacterium may be pre-plated and/or streaked on an agar plate. In some examples, a plurality of reagents may be dispensed via controlled operation by a computing device and/or an apparatus described herein and onto difference regions of the substrate containing the pre-deposited biologic sample. In some examples, the plurality of reagents may be deposited on overlapping regions to form gradients of mixtures of the reagents at different ratios and/or concentrations, such as gradients of antibiotics. The gradients may be used to measure both antibiotic susceptibility response and a response curve. Examples are not limited to antibiotics, and may include other types of reagents and biologic fluids.

In some examples involving pre-depositing the biologic sample on a substrate, non-transitory computer readable medium, such as illustrated by FIG. 1, may store instructions that when executed cause a computing device to dispense, using a first fluid ejection device, a first reagent to a region of the substrate, and dispense, using a second fluid ejection device, a metabolic indicator to the region of the substrate, wherein the metabolic indicator provides a visual indication in response to reaction with the biologic sample. In some examples, the non-transitory computer readable medium may store instructions that when executed cause the computing device to dispense, using a third fluid ejection device, a second reagent to a second region of the substrate. In some examples, a portion of the second region may overlap with a portion of the region of the substrate that the first reagent is deposited on, although examples are not so limited and the portions may not overlap. In some examples, the non-transitory computer readable medium may store the instructions that when executed cause the computing device to dispense, using the second fluid ejection device, the metabolic indicator to the region and the second region of the substrate. Examples are not limited to two reagents, and may include between one reagent and ten or more reagents, such as between two and ten reagents, two and five reagents, etc. The plurality of reagents may be deposited to form different gradients, as described above, and the resulting reactions of the different reagents and/or different gradients of reagents with the biologic sample may be concurrently measured (e.g., measure levels of the visual indication at the region and the second or more regions and determine levels of efficacy of the reagents, the different gradients of reagents and/or response curves).

In some examples involving pre-depositing the biologic sample on a substrate, an apparatus, such as illustrated by FIG. 2A, may include a dispense head including a first fluid ejection device to dispense a first reagent to a region of the substrate, a second fluid ejection device to dispense a metabolic indicator to the region (and/or a second region) of the substrate, wherein the metabolic indicator provides a visual indication in response to reaction with the biologic sample, and optionally a third (or more) fluid ejection device to dispense a second reagent (or more) to a second region of the substrate. In some examples, a portion of the second region overlaps with a portion of the first region. In some examples, the apparatus may include additional fluid ejection devices to dispense additional reagents, as described above. In some examples, such as illustrated by FIG. 2A, FIG. 2B, and/or FIG. 2C, the apparatus further includes an imaging device to obtain a measurement of the metabolic indicator across the different regions of the substrate. In some examples, as illustrated by FIG. 3, the apparatus further includes an integrated imaging stage including an array of excitation LEDs, and an ITO coated glass layer, as previously described herein.

### Experimental/More Detailed Embodiments

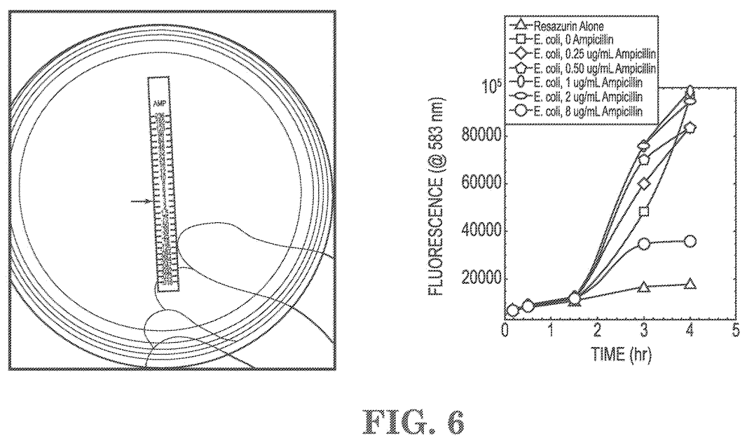

As further illustrated below in connection with the experimental embodiments, an experiment was conducted, evidencing the capability to observe levels of antibiotic activity as described in the present disclosure. The results are shown in FIG. 6.

As illustrated in the top portion of FIG. 6, a MIC test strip from Liofilchem® containing a gradient of ampicillin was applied on an agar plate coated with E. coli. The minimum inhibitory concentration of ampicillin was approximately 2 μg/mL. The E. coli was mixed with various concentrations of ampicillin (0 to 8 μg/mL) and resazurin, and the fluorescence was measured at various times. The concentrations of ampicillin used was 0 μg/mL, 0.25 μg/mL, 0.5 μg/mL, 1 μg/mL, 2 μg/mL, and 8 μg/mL. The results obtained are illustrated in the graph shown in FIG. 6. Time, measured in hours, is displayed on the x-axis, and fluorescence observed via a 583 nm wavelength lightsource, is displayed on the y-axis. The results show that for resazurin alone, the fluorescence increased from approximately 10,000 a.u. at 30 minutes, to approximately 20,000 a.u. at 3 hours and 4 hours. For the sample including E. coli and 8 μg/mL of ampicillin, the fluorescence increased from approximately 10,000 a.u. at 30 minutes, to approximately, 35,000 a.u. at 3 hours and 4 hours. For the sample including E. coli and 0 μg/mL of ampicillin, the fluorescence increased from approximately 10,000 a.u. at 30 minutes, to approximately, 50,000 a.u. at 3 hours and 10\hat{ }5 a.u at 4 hours. For the sample including E. coli and 0.25 μg/mL of ampicillin, the fluorescence increased from approximately 10,000 a.u. at 30 minutes, to approximately 60,000 a.u. at 3 hours, and approximately 80,000 a.u. at 4 hours. For the sample including E. coli and 0.5 μg/mL of ampicillin, the fluorescence increased from approximately 10,000 a.u. at 30 minutes, to approximately 70,000 a.u. at 3 hours, and approximately 80,000 a.u. at 4 hours. For the sample including E. coli and 1 μg/mL of ampicillin, the fluorescence increased from approximately 10,000 a.u. at 30 minutes, to approximately 75,000 a.u. at 3 hours, and approximately 10\hat{ }5 a.u. at 4 hours. For the sample including E. coli and 2 μg/mL of ampicillin, the fluorescence increased from approximately 10,000 a.u. at 30 minutes, to approximately 75,000 a.u. at 3 hours, and approximately 10\hat{ }5 a.u. at 4 hours.

For [ampicillin]<2 μg/mL, these data demonstrate a 6× increase in fluorescence signal compared to resazurin alone after a 4 hr incubation. At 8 μg/mL, these data demonstrate a 2× increase in fluorescence signal compared to resazurin alone after a 4 hr incubation. This is consistent with observations that ampicillin is disrupting bacterial growth at concentrations above the MIC ˜2 μg/mL.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A non-transitory computer readable medium storing instructions that when executed cause a computing device to:
dispense, using a first fluid ejector of a microfluidic device, a biologic sample to a region of a substrate;
dispense, using a second fluid ejector of the microfluidic device, a reagent to the region of the substrate; and
dispense, using a third fluid ejector of the microfluidic device, a metabolic indicator to the region of the substrate, wherein the metabolic indicator provides a visual indication in response to reaction with the biologic sample.

2. The non-transitory computer readable medium of claim 1, further including instructions that when executed cause the computing device to dispense, using the second fluid ejector, a combination of a plurality of different reagents into the region of the substrate.

3. The non-transitory computer readable medium of claim 1, wherein the reagent is to cause a chemical reaction with the biologic sample, the non-transitory computer readable medium further including instructions that when executed cause the computing device to agitate the substrate by moving the substrate along a plane.

4. The non-transitory computer readable medium of claim 1, wherein the reagent is a first reagent, and wherein the instructions to dispense the reagent to the region of the substrate includes instructions that when executed cause the microfluidic device to dispense using the second fluid ejection device, a second reagent to the region of the substrate.

5. The non-transitory computer readable medium of claim 4, wherein the region of the substrate is a first region, further including instructions that when executed cause the microfluidic device to dispense in the first region of the substrate, a first combination of the first reagent and the second reagent, and dispense in a second region of the substrate, a second combination of the first reagent and the second reagent.

6. The non-transitory computer readable medium of claim 4, wherein the region of the substrate is a first region, further including instructions that when executed cause the microfluidic device to dispense in a second region of the substrate, a combination of the first reagent and a third reagent.

7. The non-transitory computer readable medium of claim 1, further including instructions that when executed cause the computing device to:
measure a level of visual indication at the region of the substrate; and
determine a level of efficacy of the reagent based on the level of visual indication at the region.

8. An apparatus, comprising:
a dispense head including:
a first fluid ejector of a microfluidic device to dispense a biologic sample to a region of a substrate;
a second fluid ejector of the microfluidic device to dispense a reagent to the region of the substrate; and
a third fluid ejector of the microfluidic device to dispense a metabolic indicator to the region of the substrate, wherein the metabolic indicator provides a visual indication in response to reaction with the biologic sample; and
an imaging device to obtain a measurement of the metabolic indicator.

9. The apparatus of claim 8, further including a chamber to receive the substrate and incubate the biologic sample.

10. The apparatus of claim 8, wherein the metabolic indicator includes a fluorogenic compound and the imaging device includes a fluorimeter.

11. The apparatus of claim 8, wherein the reagent includes an antibiotic, an enzyme, a nucleotide, an antibody, a metabolic indicator, a detectable label, and combinations thereof.

12. The apparatus of claim 8, further including a turbidity meter.

13. An apparatus, comprising:
a dispense head of a microfluidic device including:
a first fluid ejector to dispense a biologic sample to a region of a substrate;
a second fluid ejector to dispense a reagent to the region of the substrate; and
a third fluid ejector to dispense a metabolic indicator to the region of the substrate, wherein the metabolic indicator provides a visual indication in response to reaction with the biologic sample; and
an integrated imaging stage including:
an array of excitation light-emitting diodes (LEDs); and
an indium tin oxide (ITO) coated glass layer.

14. The apparatus of claim 13, wherein the integrated imaging stage further includes a red or infrared LED.

15. The apparatus of claim 13, wherein the ITO coated glass layer is to heat the substrate responsive to application of red or infrared light, and wherein the integrated imaging stage further includes an array of sensor photodiodes to capture fluorescent measurements from the metabolic indicator on the substrate.
